(19) United States
(12) Patent Application Publication
(10) Pub. No.: US 2018/0056604 A1
(43) Pub. Date: Mar. 1, 2018

(54) ENERGY MANAGEMENT METHOD FOR PIXEL-BASED ADDITIVE MANUFACTURING

(71) Applicant: General Electric Company, Schenectady, NY (US)

(72) Inventors: Travis Gene Sands, Lebanon, OH (US); Kevin Paul McEvoy, Fairborn, OH (US); Stephen Michael Deak, Liberty Township, OH (US); Daniel Joseph Joerger, Cincinnati, OH (US); Johnny DeLeon, Mason, OH (US); Brian P. Peterson, Cincinnati, OH (US)

(21) Appl. No.: 15/248,957

(22) Filed: Aug. 26, 2016

(51) Int. Cl. B29C 67/00; B33Y 10/00; B33Y 70/00; B33Y 50/02

(52) U.S. Cl. CPC B29C 67/0066; B33Y 10/00; B33Y 50/02; B29C 67/0088; B33Y 70/00

(57) ABSTRACT

A method is provided for controlling an additive manufacturing process in which a radiant energy source is used to selectively cure a layer of resin to form a workpiece. The method includes: curing a first portion of the layer using a first application of radiant energy at a first energy level; and curing a second portion of the layer using a second application of radiant energy at a second energy level different from the first energy level.

### BACKGROUND OF THE INVENTION

This invention relates generally to additive manufacturing, and more particularly to methods for energy control in additive manufacturing.

Additive manufacturing is a process in which material is built up layer-by-layer to form a component. Stereolithography is a type of additive manufacturing process which employs a vat of liquid ultraviolet (“UV”) curable photopolymer “resin” and an image projector to build components one layer at a time. For each layer, the projector flashes a light image of the cross-section of the component on the surface of the liquid or just above the transparent lens at the bottom of the resin. Exposure to the ultraviolet light cures and solidifies the pattern in the resin and joins it to the layer below or above based on the build methodology.

The energy of the UV light source flash is variable. Less energy is required to fuse virgin uncured resin, than is required to fuse uncured resin and additionally bond the uncured resin to underlying cured structure. In the prior art, each layer is subjected to a single energy level which is sufficient to both cure and fuse material.

One problem with this approach is that the light energy tends to bleed through the upper layer to a lower layer. So for example, at the edge of a cantilevered part such as an inverted column, using the single higher energy level near the edge of the component can cause undesired curing of material below the worksurface. This results in a lack of fidelity between the intended part design and the actual workpiece, and in undesired protrusions, similar to “stalactites”.

### BRIEF DESCRIPTION OF THE INVENTION

At least one of these problems is addressed by a method of stereolithography in which multiple light flashes are used for each layer of a build.

According to one aspect of the technology described herein, a method is provided for controlling an additive manufacturing process in which a radiant energy source is used to selectively cure a layer of resin to form a workpiece. The method includes: curing a first portion of the layer using a first application of radiant energy at a first energy level; and curing a second portion of the layer using a second application of radiant energy at a second energy level different from the first energy level.

According to another aspect of the technology described herein, a method of making a workpiece includes: placing an uncured resin in a vat; positioning a build platform in the uncured resin so as to expose a layer of uncured resin; curing a first portion of the layer using a first application of radiant energy at a first energy level; and curing a second portion of the layer using a second application of radiant energy at a second energy level different from the first energy level.

### BRIEF DESCRIPTION OF THE DRAWINGS

The invention may be best understood by reference to the following description taken in conjunction with the accompanying drawing figures in which:

FIG. 1 is a schematic diagram illustrating a stereolithography apparatus;

FIG. 2 is a schematic side view of an exemplary workpiece that can be constructed using the apparatus of FIG. 1;

FIG. 3 is a view taken along lines 3-3 of FIG. 2;

FIG. 4 is a view taken along lines 4-4 of FIG. 2;

FIG. 5 is a view taken along lines 5-5 of FIG. 2;

FIG. 6 is a view taken along lines 6-6 of FIG. 2;

FIG. 7 is a view taken along lines 7-7 of FIG. 2; and

FIG. 8 is a view of FIG. 7, with a grid pattern overlaid thereon.

### DETAILED DESCRIPTION OF THE INVENTION

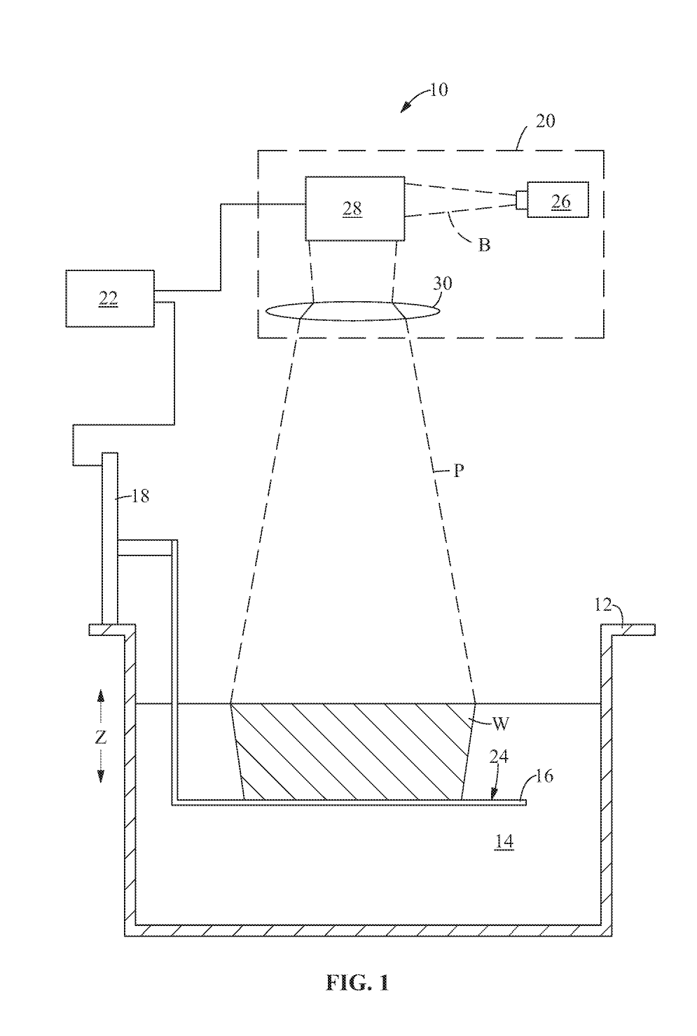

Referring to the drawings wherein identical reference numerals denote the same elements throughout the various views, FIG. 1 illustrates schematically an stereolithography apparatus 10 suitable for carrying out an additive manufacturing method as described herein. Basic components of the apparatus 10 include a vat 12 containing a photopolymer resin 14, a platform 16 connected to an actuator 18, a projector 20, and a controller 22. Each of these components will be described in more detail below.

The platform 16 is a rigid structure defining a planar worksurface 24. For purposes of convenient description, the plane of the worksurface 24 is oriented parallel to an X-Y plane of the apparatus 10, and a direction perpendicular to the X-Y plane is denoted as a Z-direction (X, Y, and Z being three mutually perpendicular directions).

The actuator 18 is operable to move the platform 16 parallel to the Z-direction. It is depicted schematically in FIG. 1, with the understanding devices such as pneumatic or hydraulic cylinders, ballscrew or linear electric actuators, and so forth, may be used for this purpose.

The projector 20 may comprise any device operable to generate a radiant energy patterned image of suitable energy level and other operating characteristics to cure the resin 14 during the build process, described in more detail below. In the illustrated example, the projector 20 comprises a radiant energy source 26 such as a UV lamp, an image forming apparatus 28 operable to receive a source beam B from the radiant energy source 26 and generate a patterned image P comprising an array of individual pixels to be projected onto the surface of the resin 14, and optionally focusing optics 30, such as one or more lenses.

The radiant energy source 26 may comprise any device operable to generate a beam of suitable energy level to cure the resin 14. In the illustrated example, the radiant energy source 26 comprises a UV flash lamp.

The image forming apparatus 28 may include one or more mirrors, prisms, and/or lenses and provided with suitable actuators, and arranged so that the source beam B from the radiant energy source 26 can be transformed into a pixelated image in an X-Y plane coincident with the worksurface 24. In the illustrated example the image forming apparatus 28 may be a digital micromirror device.

The controller 22 is a generalized representation of the hardware and software required to control the operation of the apparatus 10, including the projector 20 and actuator 18. The controller 22 may be embodied, for example, by software running on one or more processors embodied in one or more devices such as a programmable logic controller (“PLC”) or a microcomputer. Such processors may be coupled to sensors and operating components, for example, through wired or wireless connections. The same processor or processors may be used to retrieve and analyze sensor data, for statistical analysis, and for feedback control.

Generically, a build process begins by positioning the platform 16 just below the surface of the resin 14, thus defining a selected layer increment. The projector 20 projects a patterned image P representative of the cross-section of the workpiece W on the surface of the resin 14. Exposure to the radiant energy cures and solidifies the pattern in the resin 14. The platform 16 is then moved vertically downward by the layer increment. The projector 20 again projects a patterned image P. Exposure to the radiant energy cures and solidifies the pattern in the resin 14 and joins it to the previously-cured layer below. This cycle of moving the 16 and then curing the resin 14 is repeated until the entire workpiece W is complete.

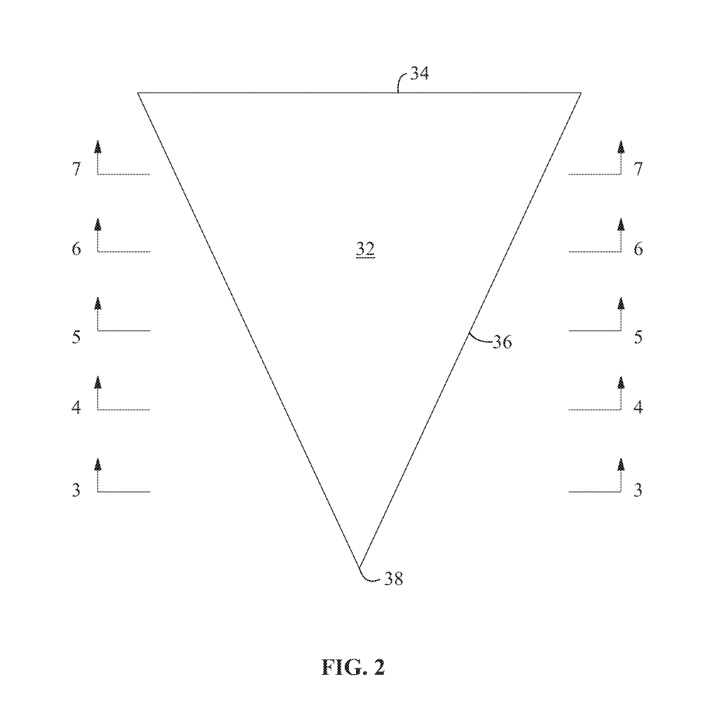

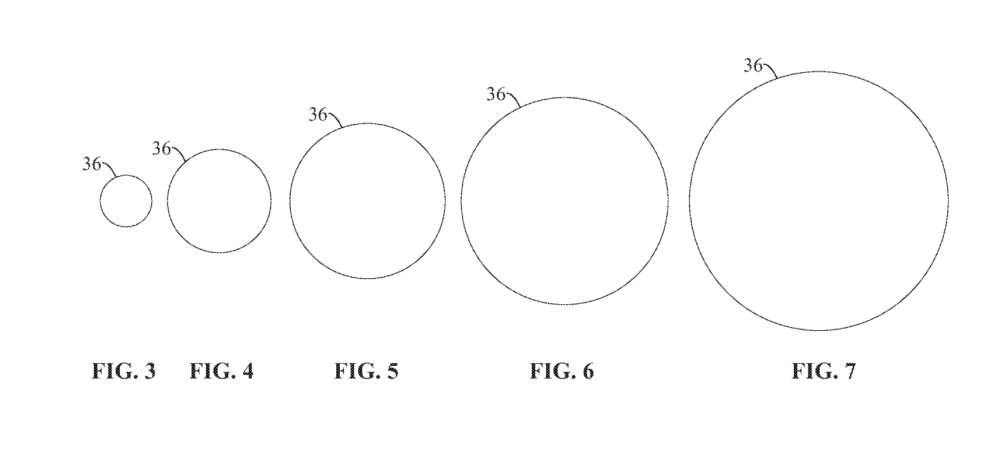

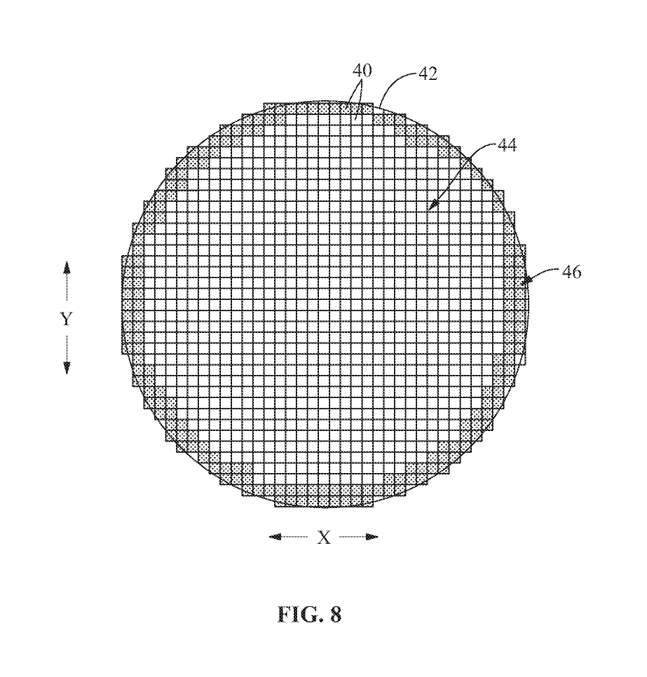

FIG. 2 shows an exemplary workpiece 32 that is generally representative of a structure having “overhanging” or “cantilevered” features. The workpiece 32 takes the form of an inverted cone having a base 34, a sidewall 36, and an apex 38. A diameter of the workpiece 32 at the base 34 is greater than the diameter of the workpiece 32 near the apex 38. The upper portions of the workpiece 32 may thus be described as laterally overhanging the lower portions. FIGS. 3 through 7 illustrate representative cross-section of the workpiece 32.

In order to produce the workpiece 32 using the apparatus 10, the workpiece 32 is modeled as a stack of planar layers arrayed along the Z-axis. Each layer is divided into a grid of pixels 40. FIG. 8 illustrates a single representative layer. It will be understood that the actual workpiece 32 may be modeled and/or manufactured as a stack of dozens or hundreds of layers.

As noted above, in the prior art, a single energy level would be used for each of the layers, the energy level being sufficient to both cure and fuse material. The problem with this procedure is that the light energy tends to bleed through the upper layer to a lower layer, causing problems in fidelity.

This problem may be overcome by using multiple flashes at differing energy levels for each layer. More specifically, each layer of the workpiece 32 is subdivided into two or more portions, and each portion is associated with a predetermined energy level. Generally speaking for purposes of best fidelity and part quality, portions located in the interior of a layer, away from an outer boundary may be associated with a higher energy level, and portions located at the periphery of a layer, at or near an outer boundary, may be associated with a lower energy level.

In the illustrated example, the layer has a peripheral edge 42 which is circular. A first portion 44 comprises the majority of the interior of the layer. This is shown in FIG. 8 by pixels 40 having a first hatch pattern. A second portion 46 comprises a ring defining the peripheral edge 42. This is shown in FIG. 8 by pixels 40 having a second hatch pattern.

Using the apparatus 10 described above, the process is carried out such that for each layer, projector 20 will flash once for each portion, using a unique patterned image for each portion. For the purposes of the present application, each flash may be described generically as an application of radiant energy.

In the illustrated example, a first patterned image corresponds to the first portion 44 and is flashed at a first, relatively high energy level. More specifically, the first energy level is consistent with the energy level required to cure the resin 14 and to bond the resin to the underlying, previously-cured layer.

A second patterned image corresponds to the second portion 46 and is flashed a at second, relatively low energy level. More specifically, the second energy level is consistent with the energy level required to cure the resin 14. Flashing at this lower second energy level reduces the risk of the UV energy bleeding through unintentionally. It is noted that the time sequence of the flashes can occur in any desired order, that is, the flash corresponding to the second portion 46 can occur before or after the flash corresponding to the first portion 44.

This process is repeated with the projector 20 flashing once for each portion until the entire workpiece 32 is complete. The technique of partitioning layers into multiple portions may be combined with the conventional technique in which one flash is provided for each layer. For example, a workpiece may include a combination of overhanging and non-overhanging areas. In the areas which are not overhanging, it may be useful to flash each layer only once at a single energy level, in order to minimize the time required.

The machine 10 and its operation are a representative example of a stereolithography apparatus having a “top-down” configuration. It will be understood that other terms are used in industry to describe similar apparatus. Furthermore it should be appreciated that the principles described here are applicable to other configurations of additive manufacturing apparatus in which the resin is cured in a layer by layer fashion, including but not limited to stereolithography apparatus which operates in a “bottom-up” configuration.

The method described herein has several advantages over the prior art. In particular, it permits better part quality and fidelity to a design intent. It assures repeatability of surface finish and geometry for pixel based layer manufactured components. This process ensures that various pixels are utilized with the proper intensity and duration at various locations in the build to optimize the features at those respective locations in the component. Increased ability to produce critical geometry, reduced variability and increased yield will result in lower part cost.

The foregoing has described a method for energy management in an additive manufacturing process. All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying potential points of novelty, abstract and drawings), or to any novel one, or any novel combination, of the steps of any method or process so disclosed.

What is claimed is:

1. A method of controlling an additive manufacturing process in which a radiant energy source is used to selectively cure a layer of resin to form a workpiece, the method comprising:
curing a first portion of the layer using a first application of radiant energy at a first energy level; and
curing a second portion of the layer using a second application of radiant energy at a second energy level different from the first energy level.

2. The method of claim 1 wherein the first application of radiant energy is applied by projecting a patterned image representative of the first portion of the layer.

3. The method of claim 2 wherein the patterned image comprises a plurality of pixels.

4. The method of claim 1 wherein the second application of radiant energy is applied by projecting a patterned image representative of the second portion of the layer.

5. The method of claim 4 wherein the patterned image comprises a plurality of pixels.

6. The method of claim 1 wherein the first portion comprises an interior of the layer and the second portion comprises a periphery of the layer.

7. The method of claim 6, wherein the second energy level is lower than the first energy level.

8. The method of claim 7 wherein:
the first energy level is selected to be sufficient to cure the resin and to bond the resin to an underlying layer of cured resin; and
the second energy level is selected to be sufficient to cure the resin.

9. The method of claim 1, further comprising prior to the step of curing, exposing an incremental thickness of uncured resin to define the layer.

10. The method of claim 9 further comprising repeating in a cycle the steps of exposing uncured resin and curing first and second portions of the layer for a series of layers, until a component is built up.

11. The method of claim 1 wherein a plurality of portions of the layer are cured using applications of radiant energy, each energy application having a unique energy level.

12. A method of making a workpiece, comprising:
placing an uncured resin in a vat;
positioning a build platform in the uncured resin so as to expose a layer of uncured resin;
curing a first portion of the layer using a first application of radiant energy at a first energy level; and
curing a second portion of the layer using a second application of radiant energy at a second energy level different from the first energy level.

13. The method of claim 12 further comprising repeating in a cycle the steps of positioning the build platform and curing first and second portions of resin, for a series of layers, so as to build up the workpiece.

14. The method of claim 12 wherein the first application of radiant energy is applied by projecting a patterned image representative of the first portion of the layer, the patterned image comprising a plurality of pixels.

15. The method of claim 12 wherein the second application of radiant energy is applied by projecting a patterned image representative of the second portion of the layer, the patterned image comprising a plurality of pixels.

16. The method of claim 12, wherein:
the first portion is an interior portion; and
the second portion of the layer is a peripheral portion.

17. The method of claim 12 wherein the first portion comprises an interior of the layer and the second portion comprises a periphery of the layer.

18. The method of claim 17 wherein the second energy level is lower than the first energy level.

19. The method of claim 18 wherein:
the first energy level is selected to be sufficient to cure the resin and to bond the resin to an underlying layer of cured resin; and
the second energy level is selected to be sufficient to cure the resin.

20. The method of claim 12 wherein a plurality of portions of the layer are cured using applications of radiant energy, each energy application having a unique energy level.
